(19) United States
(12) Patent Application Publication
(10) Pub. No.: US 2004/0213574 A1
(43) Pub. Date: Oct. 28, 2004

(54) Wavelength division multiplexing - passive optical network system

(75) Inventors: Sang Kook Han, Seoul (KR); Sang Jin Han, Seoul (KR); Ku Ik Chung, Seoul (KR); Hyuk Choon Kwon, Gangneung-si (KR)

Correspondence Address: BRUCE E. LILLING, LILLING & LILLING P.C., P.O. BOX 560, GOLDEN BRIDGE, NY, 10526, US

(73) Assignees: CORECESS, INC. Korean Corporation, Seoul (KR); Sang Kook HAN, Seoul (KR)

(21) Appl. No.: 10/284,431

(22) Filed: Oct. 30, 2002

(30) Foreign Application Priority Data
Apr. 30, 2002 (KR) 10-2002-23793

(51) Int. Cl. H04J 14/02; H04B 10/00

(52) U.S. Cl. 398/71

(57) ABSTRACT

Disclosed relates to a wavelength division multiplexing-passive optical network (WDM-PON) system that can lock wavelengths of upstream light signals output from a plurality of optical network units (ONUs) by using coherent multi-wavelength light sources and reduce mode partition noises caused when using the coherent multi-wavelength light sources. The WDM-PON system comprises a central office (CO) including a first coherent multi-wavelength light source for generating a first light signal, on which downstream data are carried, and a second coherent multi-wavelength light source for producing a second light signal, having free spectral range (FSR) intervals with the first light signal, for locking wavelengths of upstream light signals of a plurality of optical network units (ONUs); a remote node (RN), connected with the CO through a single optic fiber cable, including a wavelength-multiplexing/demultiplexing device, having a periodic pass characteristic for demultiplexing the first and second light signals received from the CO to transmit the demultiplexed signals to the respective optical network units, and for receiving the upstream light signals from the respective ONUs to multiplex the received upstream light signals to the CO; and a plurality of optical network units (ONUs), connected to the RN through each of optic fiber cables, including a light receiving means for receiving the first and second light signals, and a third coherent multi-wavelength light source, by which the wavelengths of the upstream light signals are locked to wavelengths of the second light signals.

### BACKGROUND OF THE INVENTION

1. Field of the Invention

The present invention relates to a wavelength division multiplexing-passive optical network (WDM-PON) and, more particularly, to a WDM-PON system that controls output wavelengths of optical network units (ONUs) by locking wavelengths of upstream light signals to be transmitted from the ONUs using a coherent multi-wavelength light source (component) established in a central office (CO), and by attenuating mode partition noises (MPNs) generated from the coherent multi-wavelength light source.

2. Description of the Related Art

To meet the demands for various broadband multimedia services rapidly increased in recent, there has been developed a wavelength division multiplexing-passive optical network (WDM-PON) system connected with optical network units (ONUs) directly by each of optic fiber cables. The WDM-PON system transmits multi-wavelength light signals including various character/video/audio data to the respective ONUs, service users, linked with a central office (CO), a service provider, by passive optical components,

FIG. 1 shows an outline of a conventional WDM-PON system, which comprises a central office (CO) 10, a remote node (RN) 20 and a plurality of optical network units (ONUs) 30, connected by optic fiber cables with one another. CO 10 includes a light transmitting part 11 for generating multi-wavelength light signals and transmitting the signals downstream to ONUs 30, a light receiving part 12 for receiving light signals transmitted through RN 20 upstream from the respective ONUs 30, and a circulator 13 for relaying the downstream light signals to RN 20 and the upstream light signals to the light receiving part 12. The light receiving part 12 is composed of a plurality of light receiver 121₁˜121ₙ for receiving the upstream signals according to the respective channels and a wavelength-demultiplexing device 122 for demultiplexing the upstream signals input through the circulator 13 and transmitting the demultiplexed signals to the plurality of light receivers 121₁˜121ₙ. Here, an arrayed waveguide grating (AWG) for example is adopted as the wavelength-demultiplexing device 122.

The light transmitting part 11 has a predetermined multi-wavelength light source for generating multi-wavelength light signals. Arrayed coherent light source such as a distributed feedback-laser diode (DFB-LD), or incoherent broadband light source such as an amplified spontaneous emission (ASE) can be applied as the multi-wavelength light source. The method for using the incoherent broadband light source is disclosed in a treatise [D. K. Jung, “Wavelength Division Multiplexed Passive Optical Network Based on Spectrum-Splicing Techniques”, IEEE PTL, vol. 10, pp1334˜1336, 1998]. Here, a predetermined modulator is further needed to generate multi-wavelength light signals by spectrum-splicing continuous wave (CW) light signals of the incoherent broadband light source.

RN 20 connected to CO 10 by a single optic fiber cable includes a wavelength-multiplexing/demultiplexing device 21 linked to the plurality of ONUs 30 by each of optic fiber cables. RN 20 demultiplexes the multi-wavelength light signals received from CO 10 and transmits the demultiplexed signals to ONUs 30, and multiplexes the light signals received from ONUs 30 and forwards the multiplexed signals to CO 10. Both the wavelength-demultiplexing device 122 and the wavelength-multiplexing/demultiplexing device 21 apply a 1xn arrayed waveguide grating (AWG) having a channel interval of 0.8 mm and 3 dB bandwidth of 0.32 nm.

Each of ONUs 30 includes a light transmitting part 31 for transmitting light signals upstream to CO 10 through RN 20 and a light receiving part 32 for receiving light signals transmitted through RN 20 downstream from CO 10. Here, the light transmitting part 31 uses a portion of downstream light signals from CO 10, a light source element having a peculiar wavelength, or a broadband light emitting diode (LED) as a light source for transmitting the upstream signals. Meanwhile, the light receiving part 32 uses a photo diode.

According to the above configuration, CO 10 multiplexes downstream light signals and transmits the multiplexed signals through a single optic fiber cable to RN 20. Then, RN 20 demultiplexes the signals received from CO 10 and forwards the demultiplexed signals to the plurality of ONUs 30 according to the respective channels. To the contrary, upstream light signals received from the respective ONUs 30 are multiplexed and transmitted to CO 10 through RN 20.

However, the conventional WDM-PON system as described above has several drawbacks. First, when the distributed feedback-laser diode (DFB-LD) is applied as the multi-wavelength light source of CO 10, a plurality of expensive DFB-LDs should be established in array. Besides, when the continuous wave (CW) light signals of the incoherent broadband light source are used, an expensive modulator should be further installed. Moreover, when a portion of downstream light signals from CO 10 is reused as the light source of ONU 30, the modulator is also required for every ONU 30. Furthermore, when every ONU 30 utilizes the light source element having a peculiar wavelength, the configuration of ONUs 30 becomes very complicated. In addition, when the broadband light emitting diode (LED) is applied as the light source of ONU 30, a loss of the light signal from ONU 30 may occur when the spectrum of the light signal is cut through RN 20, and the width of spectrum cut becomes wide, which deteriorates transmission rate of the upstream light signals.

Meanwhile, Korean Patent Application No. 99-59923 discloses a WDM-PON system that spectrum-slices a CW light signal output from an incoherent light source (ILS) of CO and uses the spectrum-sliced signals as an input light of a Fabry Perot-laser diode (FP-LD), a light source for transmitting upstream light signals of each of ONUs. Accordingly, the WDM-PON system cited locks wavelengths of the light signals output from FP-LD of each of ONUs, thus generating upstream light signals of the ONUs easily. Here, since 3 dB bandwidth of 1xn arrayed waveguide grating (AWG) provided in RN is approximately 0.32 nm, the spectrum width of the CW light signal sliced through AWG has a large width about 0.24 to 0.3 nm. However, the cited technique has following drawbacks. First, since the wavelengths of the input light of FP-LD are fixed as better as the spectrum width is narrower in general, it does not control the wavelengths of the light signals output from each of ONUs accurately. Besides, since the FP-LD of ONU is controlled by a light signal having a relatively large spectrum width, the output power of the upstream light signals may be decreased.

### BRIEF SUMMARY OF THE INVENTION

Accordingly, it is an object of the present invention is to provide a wavelength division multiplexing-passive optical network (WDM-PON) system comprising: a central office (CO) including a first coherent multi-wavelength light source for generating a first light signal, on which downstream data are carried, and a second coherent multi-wavelength light source for producing a second light signal, having free spectral range (FSR) intervals with the first light signal, for locking wavelengths of upstream light signals of a plurality of optical network units (ONUs); a remote node (RN), connected with the CO through a single optic fiber cable, including a wavelength-multiplexing/demultiplexing device, having a periodic pass characteristic for demultiplexing the first and second light signals received from the CO to transmit the demultiplexed signals to the respective optical network units, and for receiving the upstream light signals from the respective ONUs to multiplex the received upstream light signals to the CO; and a plurality of optical network units (ONUs), connected to the RN through each of optic fiber cables, including a light receiving means for receiving the first and second light signals, and a third coherent multi-wavelength light source, by which the wavelengths of the upstream light signals are locked to wavelengths of the second light signals.

It is a further object of the invention to provide a WDM-PON system wherein the first to third coherent multi-wavelength light sources are Fabry Perot-laser diodes (FP-LDs) and the first coherent multi-wavelength light source is driven by a low bias having an approximate value of a threshold current.

An additional object of the invention is to provide a WDM-PON system wherein the wavelength-multiplexing/demultiplexing device of the RN is a 1xn arrayed waveguide grating (AWG).

Yet another object of the invention is to provide a WDM-PON system wherein the CO further includes: a light transmitting part, having a first FP-LD, for generating the first light signal and a second FP-LD for producing the second light signal, for forwarding the first and second light signals upstream to the RN; a light receiving part for receiving the upstream light signals from the ONUs through the RN; and a circulator, connected between the light transmitting part and the light receiving part, for relaying the downstream data to RN and the upstream data to the light receiving part.

Still another object of the invention is to provide a WDM-PON system wherein the light receiving part includes: at least a light receiver for receiving the upstream light signals from the respective ONUs according to the channels; and a wavelength-demultiplexing device, connected between the light receiver and the circulator, for demultiplexing the upstream light signals of the ONUs by spectrum-slicing, and outputting the demultiplexed upstream light signals to the light receiver.

A further additional object of the invention is to provide a WDM-PON system wherein the plurality of the ONUs includes: a third band pass filter (BPF) for passing a predetermined bandwidth of the first light signal; a fourth BPF for passing a predetermined bandwidth of the second light signal; a light receiver for receiving the first light signals passed through the third BPF; and a third FP-LD for locking wavelengths of the upstream light signals, to be transmitted to the CO, according to wavelengths of the second light signals passed through the fourth BPF.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention:

In the drawings:

FIG. 1 is a block diagram depicting an outline of a conventional WDM-PON system;

FIG. 2 is a block diagram showing a configuration of a WDM-PON system in accordance with the present invention;

FIG. 3 illustrates a characteristic of free spectral range (FSR) of a wavelength-multiplexing/demultiplexing device (AWG) in FIG. 2;

FIG. 4 is a block diagram depicting a configuration of a light transmitting part 41 in FIG. 2;

FIGS. 5 to 7 are output diagrams detected when first and second DC bias currents of high bias are applied to the WDM-PON system in accordance with the invention; and

FIGS. 8 to 12 are output diagrams obtained when the first and second DC bias currents of low bias are applied to the WDM-PON system in accordance with the invention.

### DETAILED DESCRIPTION OF THE INVENTION

Reference will now be made in detail to the preferred embodiments of the present invention, examples of which are illustrated in the accompanying drawings.

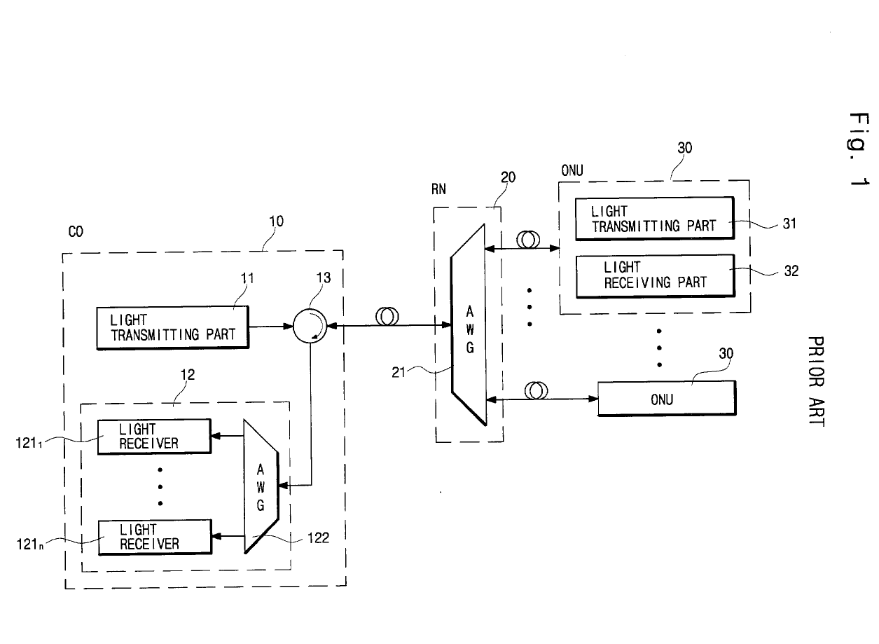

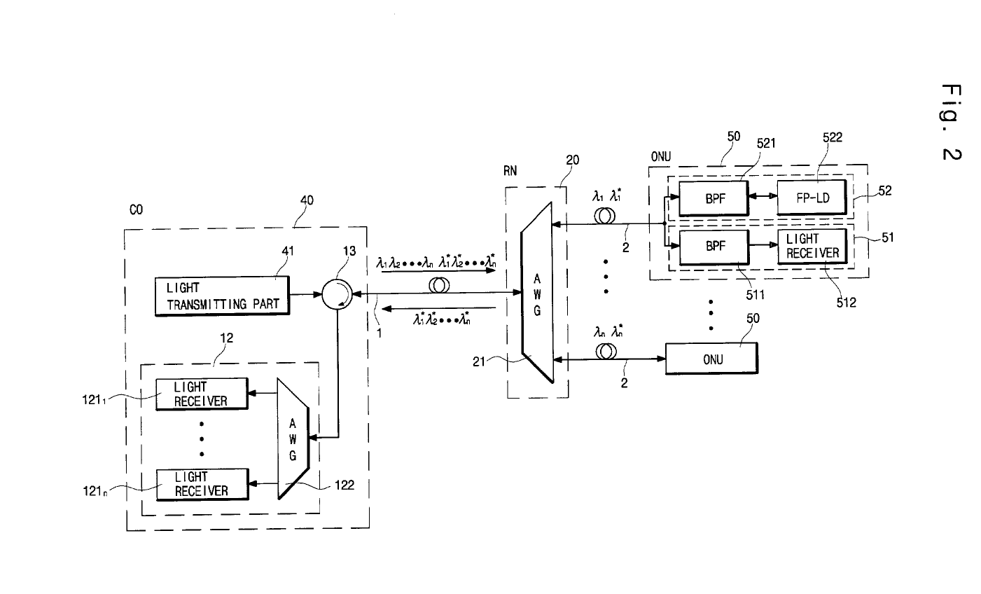

Now referring to FIG. 2, identical elements described with reference to FIG. 1 have the same reference numerals and detailed description will be omitted. a central office (CO) 40 and a remote node (RN) 20 are connected by a first optical path 1 having a length of about 20 Km or less and RN 20 and a plurality of optical network units (ONUs) 50 linked by a second optical path 2 having a length of about 5 Km or less. A light transmitting part 41 of CO 40 includes at least two coherent light sources for generating multi-wavelength light signals used for transmitting a first light signal having downstream data to the plurality of ONUs 50 and a second light signal, having a free spectral range (FSR) interval, to be described hereinafter, between the first and second light signals, for fixing wavelengths of upstream signals from the plurality of ONUs 50.

In a preferred embodiment of the invention, a Fabry Perot-laser diode (FP-LD), of which spectrum width according to output modes has a range between about 0.08 to 0.1 nm, are adopted in the light transmitting part 41 as the coherent light source. A wavelength-multiplexing/demultiplexing device 21 on RN 20 uses a 1xn arrayed waveguide grating (AWG) having channel interval of 0.8 mm and 3 dB bandwidth of 0.32 nm. Therefore, the multi-wavelength light signals output from the coherent light sources of the light transmitting part 41 are spectrum-sliced by the wavelength-multiplexing/demultiplexing device 21 with spectrum width having ample margins and forwarded to the respective ONUs 30. The light transmitting part 41 will be described in detail hereinafter.

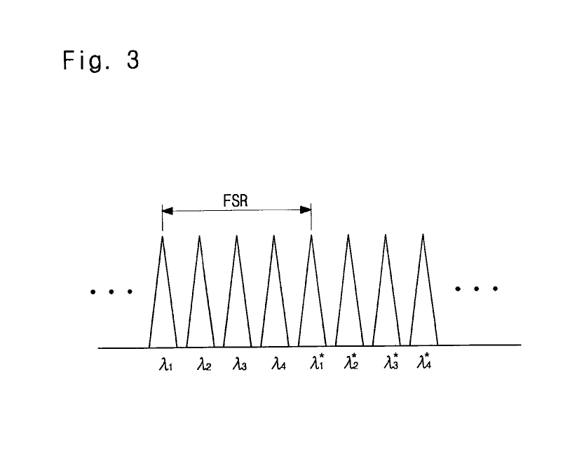

The wavelength-multiplexing/demultiplexing device (AWG) 21 has such a periodic pass characteristic that outputs a plurality of input light signals having a regular wavelength interval, i.e., a free spectral range (FSR), through identical channels (ports), As shown in FIG. 3, the wavelength-multiplexing/demultiplexing device (AWG) 21 outputs a first light signal λ₁ having a predetermined wavelength and a second light signals λ₁* having the wavelength of λ₁ plus or minus the FSR through an identical channel (port).

ONUs 30 located at each end of the second optical paths 2 receive the first and second light signals from CO 40 and lock wavelengths of upstream light signals transmitted to CO 40 according to wavelengths of second light signals

In the preferred embodiment of the invention, FP-LD is applied as the light source for transmitting the light signals from each of ONUs 30 the same manner with that of CO 40. The wavelengths of upstream light signals from each of ONUs 30 are locked according to the wavelengths of the second light signals. Accordingly, the respective ONUs 30 use identical light sources, whereas output wavelengths of ONUs 30 have different wavelengths according to the wavelengths of the second light signals.

In general, when DC bias current over a threshold current is applied to FP-LD, output modes of FP-LD are all excited to output multi-wavelength light signals having different wavelengths with each other. Whereas, if a light signal of a particular wavelength is input from outside, only an output mode having the same wavelength with the input light signal is excited, and the other output modes are not excited. The method for locking the wavelengths of ONUs 30 by inputting the light signals is adopted to use these characteristics of FP-LD.

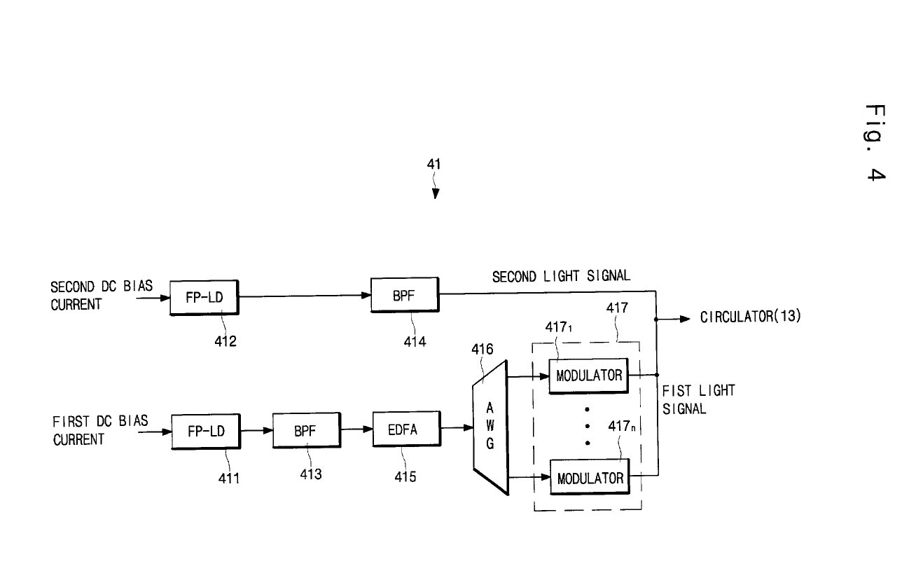

Hereinafter, the light transmitting part 41 of CO 40 will be described in detail with reference to FIG. 4.

The light transmitting part 41 comprises a first and a second Fabry Perot-laser diode (FP-LD) 411 and 412 for generating multi-wavelength light signals, a first and a second band pass filter (BPF) 413 and 414 for passing predetermined bandwidths, respectively, against the multi-wavelength light signals output from the first and second FP-LDs 411 and 412, an erbium-doped fiber amplifier (EDFA) 415 for amplifying the output lights of the first BPF 413 to have a uniform power, a wavelength-demultiplexing device 416 for multiplexing the output lights of EDFA 415 to have n-channel spectrum-slicing, and a plurality of modulators 417₁˜417ₙ for carrying downstream data on the output lights of the wavelength-demultiplexing device 416 according to n channels. Here, LiNbO₃ modulator or electro-absorption (EA) modulator, for example, can be applied as the modulator 417.

The first FP-LD 411 generates multi-wavelength light signals for producing the first light signals for carrying downstream data, and the second FP-LD 412 generates multi-wavelength signals for producing the second light signal for locking the wavelengths of ONUs 30. In the preferred embodiment, the spectrum widths according to output modes of the multi-wavelength light signals output from the first and second FP-LDs 411 and 412 are determined 0.08 nm to 0.1 nm, for example. Besides, central frequencies of the output lights from the first and second FP-LDs 411 and 412 are set to have the FSR intervals with each other. The central frequencies of bandwidths passed through the first and second BPF 413 and 414 are set to have the same FSR intervals with each other, and the respective bandwidths passed through the first and second BPF 413 and 414 have the same FSR intervals as well. Accordingly, the output light signals of the first and second FP-LDs 411 and 412 having the FSR intervals with each other are transmitted through the same channel (ports) of the wavelength-multiplexing/demultiplexing device 21 to corresponding ONU 50. The first and second FP-LDs 411 and 412 are driven by a predetermined first and second DC bias current, respectively. As a result of the test by the inventor, it was found that if the first DC bias current having a high bias, 30˜40 mA for example, is applied, output power of the first FP-LD 411 is stabilized, whereas, if the first DC bias current of low bias having a value approximate to a threshold current is applied, mode partition noises of downstream light signals are attenuated. In addition, when the first DC bias current of low bias is applied, ONU 50 can receive more satisfactory light signals than when that of high bias is applied. It is desirable that the first DC bias current is set to a range 0 to 2 mA higher than the threshold current. The threshold current of FP-LD is set in the range of 4 to 5 mA in general, however it is not fixed. Detailed description of the test results will be made hereinafter.

The mode partition noises are caused in general when AWG spectrum-slices the multi-wavelength light signals output from the coherent light source such as FP-LD. That is, mode hopping that causes pulse fluctuation between output modes of FP-LD results in the mode partition noises. The mode partition noises, which increase as much as the transmission distance of the light signals is lengthened, reduce signal to noise ratio (SNR) and deteriorate the performance of the WDM-PON system. Accordingly, when the multi-wavelength light signals of FP-LD travel a long distance, it is necessary to attenuate the mode partition noises. A method for attenuating the noises using semiconductor optical amplifier (SOA) is proposed in a treatise [Kenju Sato, Hiromu Toba, “Reduction of Mode Partition Noise by Using Semiconductor Optical Amplifier”, IEEE J. Quantum Electron, vol. 7. pp328˜333, 2001]. According to the method, a plurality of SOAs should be provided to each of the output wavelengths of the multi-wavelength light signals, which requires high cost. However, the problem can be solved easily by applying a low DC bias current having an approximated value of the threshold current to FP-LD, as the inventor proposed.

Meanwhile, since the multi-wavelength light signals output from the second FP-LD 412 without spectrum-splicing in CO 40 are used for locking the output wavelengths of ONUs 50, they are affected by the mode partition noises less than those output from the first FP-LD 411. Accordingly, it is possible that the first DC bias current is set low, and the second DC bias current is set high about 30 to 40 mA for example so that the output power of the second FP-LD 412 is stabilized. More preferably, it is possible to set the first and second DC bias currents low. Here, it is desirable that an erbium-doped fiber amplifier (EDFA), not depicted, is connected to an output end of the second BPF 414 so that the output power of the second FP-LD 412 is stabilized.

Meanwhile, each of the plurality of ONUs 50 in FIG. 2 comprises a light receiving part 51 for receiving only the first light signal among the downstream light signals transmitted from CO 40, and a light transmitting part 52 for receiving only the second light signal among the downstream light signals and locking upstream light signals, to be forwarded to CO 40, to the wavelength of the second light signal received. A coupler, not depicted, connects the light receiving part 51 and the light transmitting part 52. The light receiving part 51 includes a third band pass filter (BPF) 511 for passing the bandwidth of the first light signal and a light receiver 512 for receiving the first light signal passed through the third BPF 511. The light receiver 512 is a photo diode, for example. The light transmitting part 52 includes a fourth band pass filter (BPF) 521 for passing the bandwidth of the second light signal and a third Fabry Perot-laser diode (FP-LD) 522 for receiving the second light signal passed through the fourth BPF 521 and locking upstream light signals, to be forwarded to CO 40, to the wavelength of the second light signal received.

Hereinafter, operations of the WDM-PON system in accordance with the present invention having the above configuration will be described.

First, to transmit downstream data from CO 40 to the respective ONUs 50, when the first FP-LD 411 of CO 40 in FIG. 4 driven by the first DC bias current outputs multi-wavelength light signals, the first BPF 413 passes a predetermined bandwidth of the signals and the EDFA 415 amplifies the signals in turn. The output lights of the EDFA 415 are spectrum-sliced to have n channels by the wavelength-demultiplexing device 416, and then, modulated by the modulators 417₁˜417ₙ to have a predetermined bit rate, i.e., 522 Mbps, thus generating the first light signals having downstream data to the circulator 13. At the same time, the second FP-LD 412 of CO 40 driven by the second DC bias current outputs multi-wavelength light signals for locking the wavelengths of upstream light signals from the ONUs 50. The multi-wavelength light signals are filtered to have a predetermined bandwidth by the second BPF 414 and transmitted to the circulator 13 as the second light signals.

Referring back to FIG. 2, the circulator 13 mixes the first light signals (λ₁λ₂ . . . λₙ) and the second light signals (λ₁*λ₁ . . . λₙ*) and transmits the mixed signals to RN 20. Here, the central frequencies of the first and second light signals to be forwarded to the respective ONUs 50 have FSR intervals with each other. Then, the wavelength-multiplexing/demultiplexing device 21 of RN 20 demultiplexes the first and second light signals received from CO 40 according to the channels and transmits the first light signals (λₓ, 1≦X≦n) and the second light signals (λₓ*, 1≦X≦n) having FSR intervals with each other to the plurality of ONUs 50 connected to the respective channels. Then, the third BPF 511 of each of the ONUs 50 filters the first light signals and transmits to the light receiver 512, and the fourth BPF 521 filters the second light signals and forwards to the third FP-LD 522 as the CW light signal for locking the wavelength of upstream light signal.

Next, to transmit upstream light signals from ONUs 50 to CO 40, the third FP-LD 522 locks the wavelengths of upstream light signals to those of the second light signals and transmits the locked light signal to RN 20. The RN 20 collects upstream light signals from ONUs 50 and forwards the collected light signal (λ₁*λ₁ . . . λₙ*) to CO 40. Then, the circulator 13 of CO 40 sends the received upstream light signals to the wavelength-demultiplexing device (AWG) 122 of the light receiving part 12. The wavelength-demultiplexing device (AWG) 122 spectrum-slices the received light signals and forwards to the plurality of the light receivers 121 connected to the respective channels.

Hereinafter, test results by the inventor in terms of high or low level of the first and second DC bias currents applied to the first and second FP-LDs 411 and 412 in accordance with the invention will be discussed.

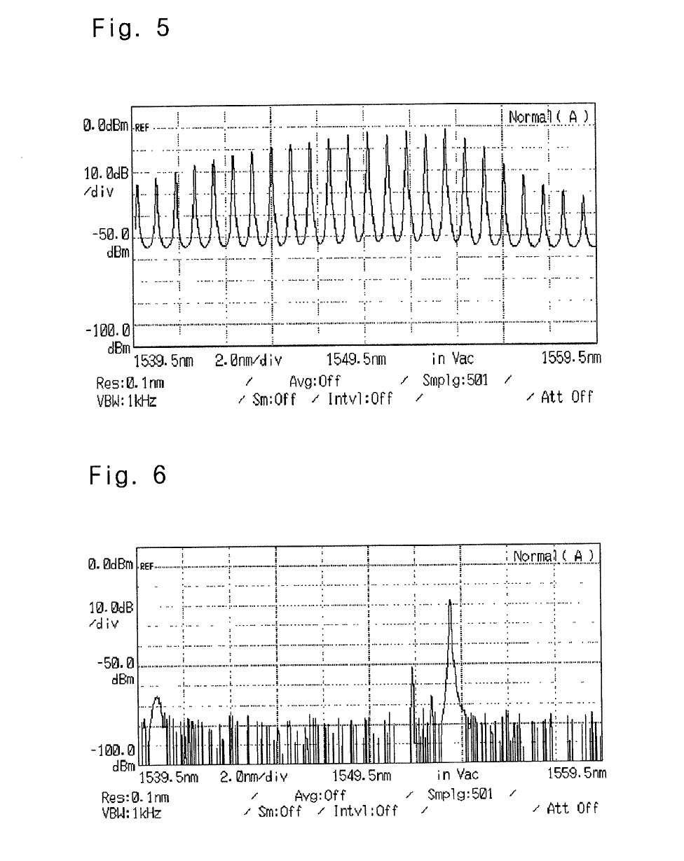

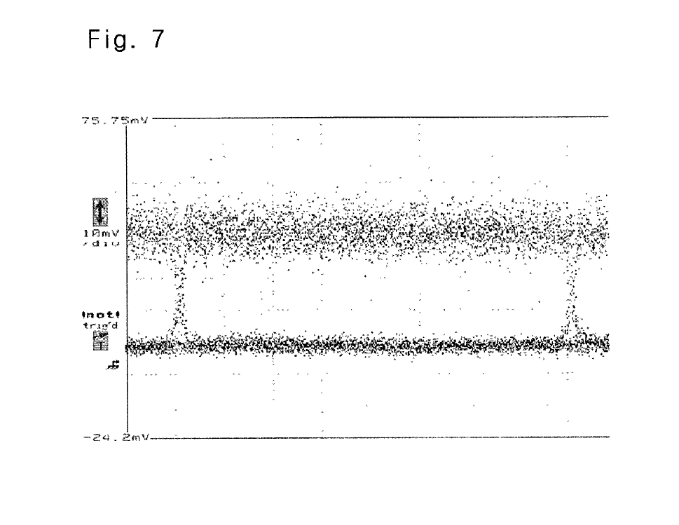

First, FIGS. 5 to 7 show various output diagrams detected when the first and second DC bias currents having high bias of 30˜40 mA are applied to the FP-LDs 411 and 412. Here, the first FP-LD 411 in FIG. 4 generated multi-wavelength light signals having a spectrum depicted in FIG. 5. It was noted that a sufficient power of 4 dBm approximately is obtained at output ends of the wavelength-demultiplexing device 416. Besides, it was found that the light receiver 512 of ONU 50 receives a light signal having a satisfactory power of −17 dBm approximately as depicted in FIG. 6. Eye patterns having relatively low deterioration of the light received was detected as shown in FIG. 7. In general the eye patterns are shown distorted when the light signals are deteriorated by noises in telecommunications system.

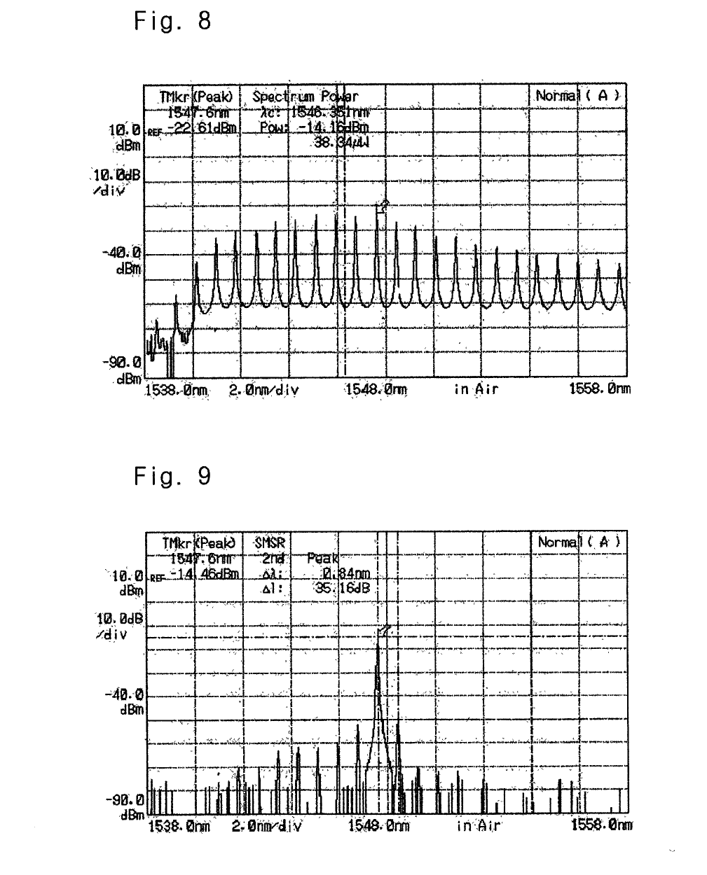

Next, FIGS. 8 to 12 show various output diagrams obtained when the first and second DC bias currents of bias having values approximate to the threshold current are applied to the FP-LDs 411 and 412. Meanwhile, the second DC bias current applied has a high bias of 30˜40 mA. In this test, FP-LDs having the threshold current of 4 mA and central frequencies of 1.55□ are adopted. It was learned that the first FP-LD 411 in FIG. 4 generated multi-wavelength light signals having a spectrum shown in FIG. 8. Besides, it was noted that the output power of 2 dBm approximately is obtained at the output ends of the wavelength-demultiplexing device 416. Moreover, the light receiver 512 of ONU 50 received a light signal having a relatively satisfactory power of −18 dBm approximately as depicted in FIG. 9.

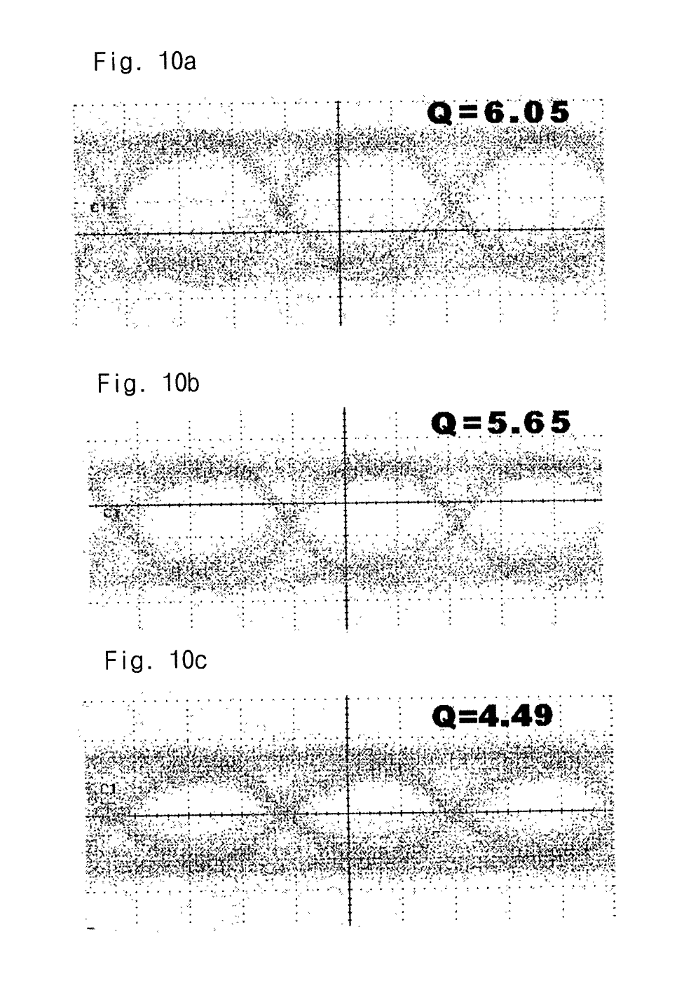

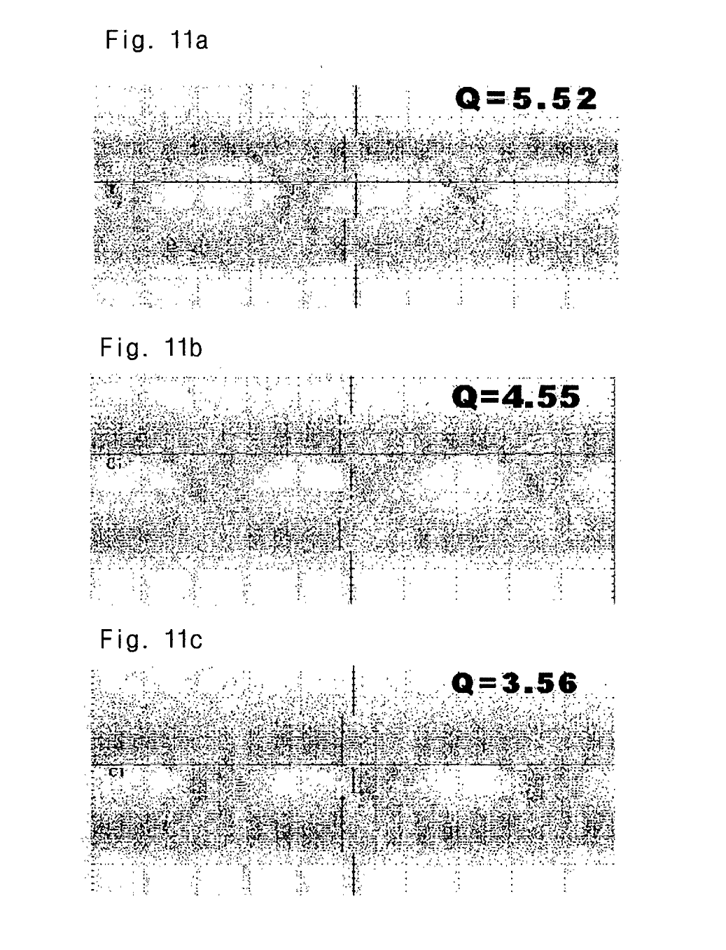

FIGS. 10a, 10b and 10c show eye patterns of the first light signals detected at an input end of the circulator 13, at a transmitting point of 10 Km, and at another transmitting point of 20 Km, respectively, when the first DC bias current of 5 mA is applied. FIGS. 11a, 11b and 11c depict eye patterns of the first light signals detected at the above points, respectively, when the first DC bias current of 7 mA is applied. Q factor is expressed as a parameter for comparing the mode partition noises on every diagram. Since the first light signals are less affected by the mode partition noises as Q factor has a larger value, it can be noted that more satisfactory light signals are transmitted if the first DC bias current applied is of 5 mA than if that is of 7 mA at every point.

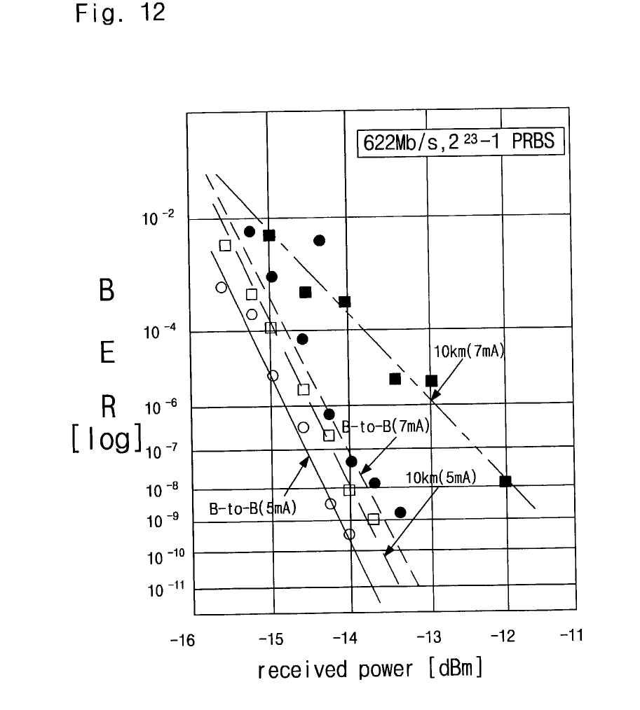

FIG. 12 illustrates variations of bit error rates (BER) at the input end of the circulator 13 (B-to-B) and at the transmitting point of 10 Km when the first DC bias currents of 5 mA and 7 mA are applied, respectively. It can be seen from the figure that the respective bit error rates are lower in case that the first DC bias current applied is 5 mA. Accordingly, if FP-LDs are driven by a predetermined bias current having an approximate value of the threshold current, the mode partition noises are reduced substantially.

According to the present invention as described above, it is possible to lock the wavelengths of ONUs simply by supplying from CO to ONUs light signals for locking the wavelengths of upstream light signals. Since every ONU uses an identical FP-LD as a light source for transmitting upstream data, the WDM-PON system in accordance with the invention can be established economically.

Besides, since the FP-LD having a narrow spectrum width is adopted as the multi-wavelength light source for locking the wavelengths of upstream light signals, in case that common broadband light sources are applied by the spectrum-slicing, every ONU can lock the wavelengths of upstream light signals more precisely and prevent the output power loss caused when forwarding upstream data to CO.

Furthermore, the WDM-PON system of the invention can reduce the mode partition noises substantially, caused when transmitting downstream light signals, by driving the FP-LD with the DC bias current of low bias having a value approximate to the threshold current, without further establishment of the expensive semiconductor optical amplifiers (SOA).

In addition, according to the invention, it is possible to reduce the mode partition noises considerably, caused when using coherent light sources as the multi-wavelength light source of CO, by driving the coherent light source with the DC bias current of low bias having a value approximate to the threshold current.

It will be apparent to those skilled in the art that various modifications and variations can be made in the WDM-PON system of the present invention without departing from the spirit or scope of the invention. Thus, it is intended that the present invention cover the modifications and variations of this invention provided they come within the scope of the appended claims and their equivalents.

What is claimed is:

1. A wavelength division multiplexing-passive optical network (WDM-PON) system comprising:
a central office (CO) including a first coherent multi-wavelength light source for generating a first light signal, on which downstream data are carried, and a second coherent multi-wavelength light source for producing a second light signal, having free spectral range (FSR) intervals with the first light signal, for locking wavelengths of upstream light signals of a plurality of optical network units (ONUs);
a remote node (RN), connected with the CO through a single optic fiber cable, including a wavelength-multiplexing/demultiplexing device, having a periodic pass characteristic for demultiplexing the first and second light signals received from the CO to transmit the demultiplexed signals to the respective optical network units, and for receiving the upstream light signals from the respective ONUs to multiplex the received upstream light signals to the CO; and
a plurality of optical network units (ONUs), connected to the RN through each of optic fiber cables, including a light receiving means for receiving the first and second light signals, and a third coherent multi-wavelength light source, by which the wavelengths of the upstream light signals are locked to wavelengths of the second light signals.

2. The WDM-PON system as recited in claim 1,
wherein the first to third coherent multi-wavelength light sources are Fabry Perot-laser diodes (FP-LDs).

3. The WDM-PON system as recited in claim 1,
wherein the first coherent multi-wavelength light source is driven by a DC bias current of low bias having a value approximate to a threshold current.

4. The WDM-PON system as recited in claim 1,
wherein the first and second coherent multi-wavelength light sources are driven by a DC bias current of low bias having a value approximate to a threshold current; and
the second coherent multi-wavelength light source having a predetermined means for amplifying output lights of the second coherent multi-wavelength light source.

5. The WDM-PON system as recited in claim 1,
wherein the wavelength-multiplexing/demultiplexing device of the RN is a 1xn arrayed waveguide grating (AWG).

6. The WDM-PON system as recited in claim 1,
wherein the first to third coherent multi-wavelength light sources are Fabry Perot-laser diodes (FP-LDs); and
wherein the CO further includes:
a light transmitting part, having a first FP-LD, for generating the first light signal and a second FP-LD for producing the second light signal, for forwarding the first and second light signals downstream to the RN;
a light receiving part for receiving the upstream light signals from the ONUs through the RN; and
a circulator, connected between the light transmitting part and the light receiving part, for relaying the downstream light signals to RN and the upstream light signals to the light receiving part.

7. The WDM-PON system as recited in claim 6,
wherein the light transmitting part further includes:
a first Fabry Perot-laser diode (FP-LD) for generating multi-wavelength light signals for producing the first light signal;
a first band pass filter (BPF) for passing a predetermined bandwidth of the multi-wavelength light signals output from the first FP-LD;
an erbium-doped fiber amplifier (EDFA) for amplifying output light signals passed through the first BPF to have a uniform power between channels;
a wavelength-demultiplexing device for demultiplexing output light signals of EDFA 415 to have n-channel by spectrum-slicing;
at least a modulator for modulating output light signals of the wavelength-demultiplexing device to carry downstream light signals on the output lights of the wavelength-demultiplexing device according to the n-channels;
a second Fabry Perot-laser diode (FP-LD) for generating multi-wavelength light signals for producing the second light signal; and
a second band pass filter (BPF) for passing a predetermined bandwidth of the multi-wavelength light signals output from the second FP-LD.

8. The WDM-PON system as recited in claim 7,
wherein central frequencies of the multi-wavelength light signals output from the first and second FP-LDs have the same free spectral range (FSR) intervals with each other;
central frequencies of the bandwidths passed through the first and second BPFs have the same FSR intervals, respectively; and
the bandwidths of the first and second BPFs are set the same FSR intervals, respectively.

9. The WDM-PON system as recited in claim 7, wherein the wavelength-demultiplexing device is a 1xn arrayed waveguide grating (AWG).

10. The WDM-PON system as recited in claim 6,
wherein the light receiving part includes:
at least a light receiver for receiving the upstream light signals from the respective ONUs according to the channels; and
a wavelength-demultiplexing device, connected between the light receiver and the circulator, for demultiplexing the upstream light signals of the ONUs by spectrum-slicing, and outputting the demultiplexed upstream light signals to the light receiver.

11. The WDM-PON system as recited in claim 1,
wherein the first to third coherent multi-wavelength light sources are Fabry Perot-laser diodes (FP-LDs); and
wherein the plurality of the ONUs includes:
a third band pass filter (BPF) for passing a predetermined bandwidth of the first light signal;
a fourth BPF for passing a predetermined bandwidth of the second light signal;
a light receiver for receiving the first light signals passed through the third BPF; and
a third FP-LD, by which the wavelengths of the upstream light signals are locked to wavelengths of the upstream light signals, according to the wavelengths of the second light signals passed through the fourth BPF.
